(19) United States
(12) Patent Application Publication
(10) Pub. No.: US 2022/0137563 A1
(43) Pub. Date: May 5, 2022

(54) SUSPENDED CLOCK

(71) Applicant: Umbra LLC, Buffalo, NY (US)

(72) Inventor: Sung Wook Park, Toronto (CA)

(21) Appl. No.: 17/085,370

(22) Filed: Oct. 30, 2020

(51) Int. Cl. G04B 19/10; G04B 19/06

(52) U.S. Cl. CPC G04B 19/10; G04B 19/065

(57) ABSTRACT

A suspended clock, comprising a transverse support rod, a casing, the casing comprising a movement, a hand shaft engaging the movement and arranged for rotational timed movement, and at least two hands secured to the hand shaft and arranged for rotation about the hand shaft, the casing suspended from the transverse support rod; and, a plurality of hour markers suspended from the transverse support rod, arranged in a circle, and spaced apart from the casing.

### FIELD

The present invention relates to horological instruments generally, more specifically to clocks, and more specifically, to a suspended clock.

### BACKGROUND

The clock is one of the oldest human inventions and serves to measure intervals of time shorter than the natural unit of the day. However, traditionally in horology, the term clock was used for a striking clock, while a clock that did not strike the hours audibly was called a timepiece. As this distinction is largely unknown to the modern population, the two terms may be used interchangeably unless specified otherwise.

Sundials and water clocks are some of the earliest predecessors to the modern clock. A sundial shows the time by displaying the position of a shadow on a flat surface while a water clock measures time by regulating the flow of water (or any liquid) into or out from a vessel and measuring that input or output. These devices measured time by a continuous process and allowed for some error, for example liquids with different viscosities flow at different rates and the sun is in different positions in the sky in the different seasons (spring, summer, fall, winter) and even day to day. The introduction of the verge, or crown wheel, escapement around the year 1300 shifted the measuring of time to repetitive, oscillatory processes which had the potential to be much more accurate and reliable. During the 15^{th} and 16^{th} centuries, clockmaking flourished and saw the introduction of spring-driven clocks and pendulum clocks which led to another major improvement in accuracy and reliability and allowed for even more precise time-keeping for navigation. The latest major development was the introduction of the electronic clock which eventually led to clocks with no “clockwork” parts at all following the advancement of electronics in the 20^{th} century.

However, not much has changed regarding mechanical or analog clocks over the years. The time-keeping element in almost every modern clock is a harmonic oscillator, a physical object (resonator) that vibrates or oscillates at a particular frequency. This object can be a pendulum, a tuning fork, a quartz crystal, or the vibration of electrons in atoms as they emit microwaves.

A clock face is the part of an analog clock (or watch) that displays time through the use of a flat dial with reference marks, and revolving pointers turning on concentric shafts at the center, called hands. The modern clock face has not undergone any significant changes for centuries either. The introduction of the digital clock led to a new way of displaying time, but the clock face is still universally known and understood. In its most basic, globally recognized form, the periphery of the face is numbered 1 through 12 indicating the hours in a 12-hour cycle, and a short hour hand makes two revolutions in a day. A long minute hand makes one revolution every hour. The face may also include a second hand, which makes one revolution per minute. It should also be appreciated that a second type of clock face is the 24-hour analog face, widely used in military and other organizations that use 24-hour time. This is similar to the 12-hour face above, except it has hours numbered 1-24 around the periphery of the face, and the hour hand makes only one revolution per day. Most clock faces are perfectly circular with each hour marker evenly spaced around the perimeter of the face. For clock faces with 12 hour markers, each is spaced 30 degrees apart with the 12 hour marker being the top of the circle, the 3 hour marker being the right most hour marker, the 6 hour marker being the bottom, and the 9 hour marker being the left most hour marker. Clock faces, traditionally, use Roman Numerals or Arabic Numerals to indicate the hour at each hour marker. However, because the clock face is so familiar globally, anything can be used to mark each hour. People understand the position of each hour without the actual number indicating same.

Traditionally, the hour markers are located around the perimeter of the circular clock face. Aesthetically, it may be pleasing to have the hour markers positioned away from the clock face. However, the hour markers must still be evenly spaced 30 degrees apart around the center shaft of the clock face. So, at each desired distance away from the center shaft, each hour marker has a predetermined position in order to maintain the 30 degrees of separation and a perfect circle around the center shaft. Aesthetically, it may also be pleasing to have all of the elements of the clock, such as the clock face and hour markers, suspended in the air.

Thus, there is a long felt need for a suspended clock.

### SUMMARY

The present invention broadly comprises a suspended clock, comprising a transverse support rod, a casing, the casing comprising a movement, a hand shaft engaging the movement and arranged for rotational timed movement, and at least two hands secured to the hand shaft and arranged for rotation about the hand shaft, the casing suspended from the transverse support rod; and, a plurality of hour markers suspended from the transverse support rod, arranged in a circle, and spaced apart from the casing.

A general object to this invention is to provide a suspended clock.

This and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of the suspended clock of the present invention;

FIG. 2 is a front elevational view of the suspended clock shown in FIG. 1;

FIG. 3 is a rear elevational view of the suspended clock shown in FIG. 1;

FIG. 4 is a left side elevational view of the suspended clock shown in FIG. 1;

FIG. 5 is a right side elevational view of the suspended clock shown in FIG. 1;

FIG. 6 is a top plan view of the suspended clock shown in FIG. 1; and,

FIG. 7 is a bottom plan view of the suspended clock shown in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

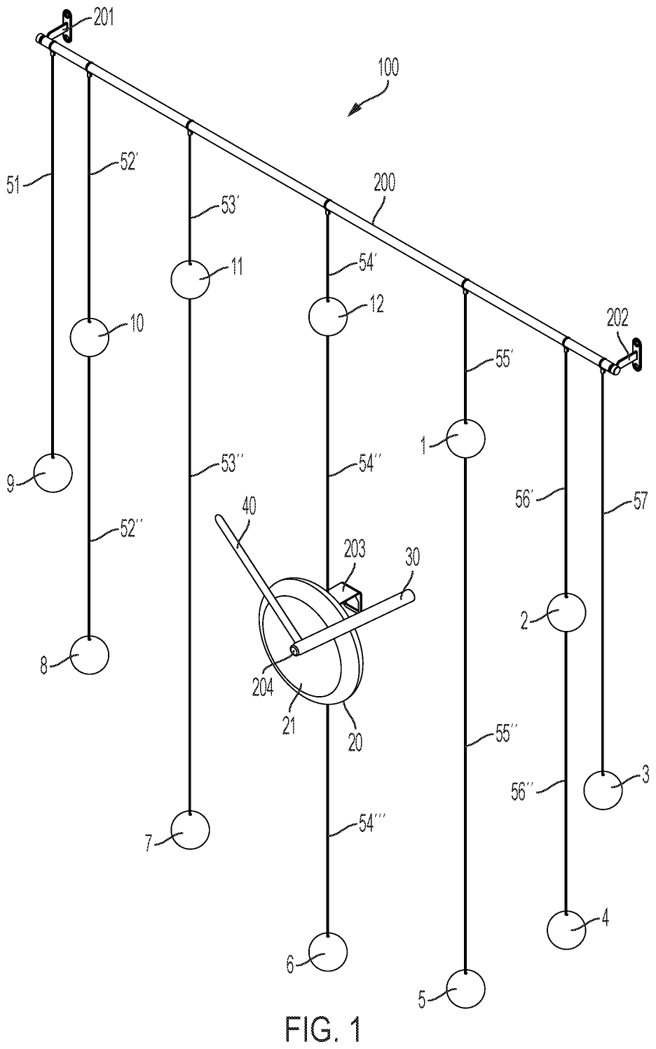

Referring now to the figures, FIG. 1 is a front perspective view of suspended clock 100. Suspended clock 100 generally comprises transverse support rod 200, first and second transverse support rod mounting brackets 201 and 202, casing 20, casing mounting bracket 203, clock face 21, hand shaft 204, minute hand 30, hour hand 40, 1 o'clock hour marker 1, 2 o'clock hour marker 2, 3 o'clock hour marker 3, 4 o'clock hour marker 4, 5 o'clock hour marker 5, 6 o'clock hour marker 6, 7 o'clock hour marker 7, 8 o'clock hour marker 8, 9 o'clock hour marker 9, 10 o'clock hour marker 10, 11 o'clock hour marker 11, 12 o'clock hour marker 12, first suspension cable 51, upper second suspension cable 52′, lower second suspension cable 52″, upper third suspension cable 53′, lower third suspension cable 53″, upper fourth suspension cable 54′, middle fourth suspension cable 54″, lower fourth suspension cable 54″, upper fifth suspension cable 55′, lower fifth suspension cable 55″, upper sixth suspension cable 56′, lower sixth suspension cable 56″, and seventh suspension cable 57. Transverse support rod 200 is operatively arranged to be secured to a wall by first and second transverse support rod mounting brackets 201 and 202. Transverse support rod mounting brackets 201 and 202 are operatively arranged at either end of transverse support rod 200 and when fully secured to the wall, transverse support rod 200 rests substantially parallel to a floor surface and/or a ceiling surface.

Suspension cables 51-57 are fixedly secured to and suspended from transverse support rod 200 at specific locations. As transverse support rod 200 is secured substantially parallel to a ground or floor surface, suspension cables 51-57 suspend substantially perpendicular to transverse support rod 200 and the ground or floor surface. While suspension cables 51-57 are located at specific locations along transverse support rod 200, they are also suspended in a specific order along transverse support rod 200. First suspension cable 51 is located at one end of transverse support rod 200 and seventh suspension cable 57 is located at the other end of transverse support rod 200 with upper and lower second suspension cable 52′ and 52″ located proximate to first suspension cable 51, upper and lower sixth suspension cable 56′ and 56″ located proximate to seventh suspension cable 57. Upper and lower third suspension cable 53′ and 53″ is located proximate to upper and lower second suspension cable 52′ and 52″ but not proximate to first suspension cable 51. Similarly, upper and lower fifth suspension cable 55′ and 55″ is located proximate to upper and lower sixth suspension cable 56′ and 56″ but not proximate to seventh suspension cable 57. Lastly, upper, middle, and lower fourth suspension cable 54′, 54″, and 54″ is in between upper and lower third suspension cable 53′ and 53″ and upper and lower fifth suspension cable 55′ and 55″.

Suspension cables 51-57 are of varying lengths, however first suspension cable 51 and seventh suspension cable 57 are shortest and are of same or similar length, upper and lower second suspension cable 52′ and 52″ (when combined) and upper and lower sixth suspension cable 56′ and 56″ (when combined) are next shortest and are of same or similar length, upper and lower third suspension cable 53′ and 53″ (when combined) and upper and lower fifth suspension cable 55′ and 55″ (when combined) are next shortest and are of same or similar length, and upper, middle, and lower fourth suspension cable 54′, 54″, and 54″ (when combined) is the longest of the seven suspension cables.

In a preferred embodiment, suspension cables 51-57 are made of durable cables, but in other potential embodiments, suspension cables 51-57 can be made of any material that will rest in a substantially perpendicular position to the ground or floor surface and/or ceiling surface due to gravity, such as fishing line, wires, bungee-cords, etc.

9 o'clock hour marker 9 is secured to the distal end of first suspension cable 51 and 3 o'clock hour marker 3 is secured to the distal end of seventh suspension cable 57. 8 o'clock hour marker 8 is secured to the distal end of lower second suspension cable 52″ and 4 o'clock hour marker 4 is secured to the distal end of lower sixth suspension cable 56″. 10 o'clock hour marker 10 is secured between 8 o'clock hour marker 8 and transverse support rod 200 at the location that defines where upper second suspension cable 52′ transitions into lower second suspension cable 52″. 2 o'clock hour marker 2 is secured between 4 o'clock hour marker 4 and transverse support rod 200 at the location that defines where upper sixth suspension cable 56′ transitions into lower sixth suspension cable 56″. Additionally, 10 o'clock hour marker 10 and 2 o'clock hour marker 2 are secured at the same or similar distance from 8 o'clock hour marker 8 and 4 o'clock hour marker 4, respectively. 7 o'clock hour marker 7 is secured to the distal end of lower third suspension cable 53″ and 5 o'clock hour marker 5 is secured to the distal end of lower fifth suspension cable 55″. 11 o'clock hour marker 11 is secured between 7 o'clock hour marker 7 and transverse support rod 200 at the location that defines where upper third suspension cable 53′ transitions into lower third suspension cable 53″. 1 o'clock hour marker 1 is secured between 5 o'clock hour marker 5 and transverse support rod 200 at the location that defines where upper fifth suspension cable 55′ transitions into lower fifth suspension cable 55″. Additionally, 11 o'clock hour marker 11 and 1 o'clock hour marker 1 are secured at the same or similar distance from 7 o'clock hour marker 7 and 5 o'clock hour marker 5, respectively. Lastly, 6 o'clock hour marker 6 is secured to the distal end of lower fourth suspension cable 54″ and 12 o'clock hour marker 12 is secured at the location that defines where upper fourth suspension cable 54′ transitions into middle fourth suspension cable 54″ and is a position closest to transverse support rod 200 when compared with all other hour markers. Perfectly between 12 o'clock hour marker 12 and 6 o'clock hour marker 6 casing 20 is secured at the location that defines where middle fourth suspension cable 54″ transitions into lower fourth suspension cable 54″ such that casing 20 is equidistant from 12 o'clock hour marker 12 and 6 o'clock hour marker 6. Casing 20, while substantially suspended from transverse support rod 200, may be secured to a wall surface via casing mounting bracket 203 for stability.

In a preferred embodiment, hour markers 1-12 are spheres. However, in other embodiments, hour markers 1-12 can take many shapes and sizes, including but not limited to, a cube, a disk, an octahedron, obolid, and a numeral.

Clock face 21 is fixedly secured to casing 20 which are both perfect circles with slightly different diameters—casing 20 having a slightly longer diameter than clock face 21. Hand shaft 204 is fixedly secured to the center of clock face 21 and casing 20. Minute hand 30 and hour hand 40 are secured to hand shaft 204 such that both minute hand 30 and hour hand 40 extend radially from hand shaft 204 and therefore the center of clock face 21. In a preferred embodiment, the movement of minute hand 30 and hour hand 40 is provided by a Young Town Taiwan Sweep Quartz Movement with Silent Clock Hands Mechanism manufactured by Dongguan Young Town Co., Ltd. https://youngtownco.com/en/product-493625/Continuous-Sweep-Clock-Movements-12888ST.html Minute hand 30 and hour hand 40 are operatively arranged to attach to and rotate about the clock movement mechanism provided.

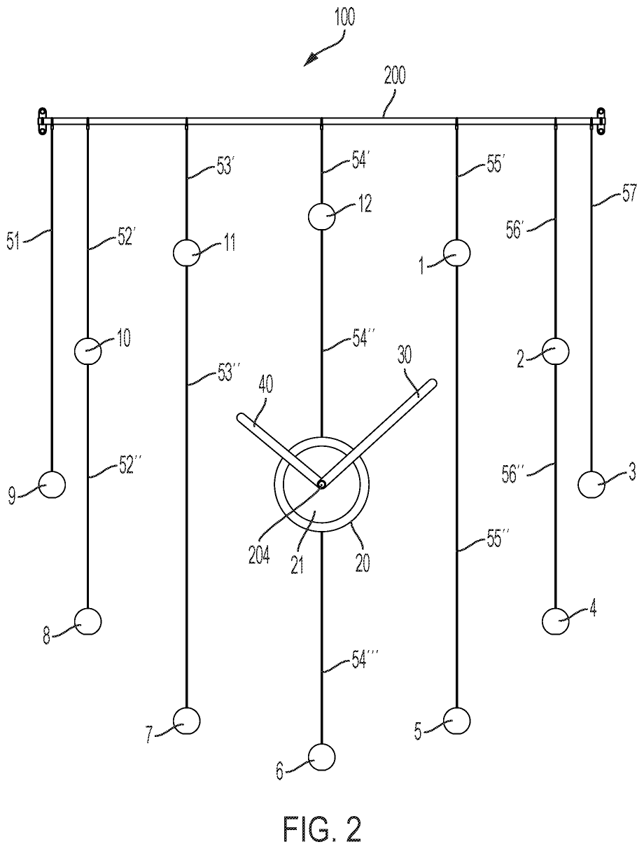

FIG. 2 is a front elevational view of the suspended clock shown in FIG. 1 and further illustrates the symmetric nature of the clock and certain other features. Specifically, Minute hand 30 is substantially longer than hour hand 40, as is well known in the art. Hour markers 1-12 are operatively arranged to form a perfect circle around hand shaft 204. Thus, each hour marker 1-12 is equidistant from hand shaft 204. Additionally, each hour marker 1-12 is operatively arranged to represent an hour of the day (notwithstanding a.m. and p.m.). As analog clock reading is essentially a universally known skill, the majority of people do not need actual numerical representations to know which location around the clock represents which hour. The spacing and location of suspension cables 51-57 and hour markers 1-12 create thirty-degree differences between each hour marker 1-12 in relation to hand shaft 204 as is known in the art. So, as hour hand 40 and minute hand 30 rotate about hand shaft 204, hour hand 40 and minute hand 30 are meant to indicate the time of the day as represented by hour markers 1-12.

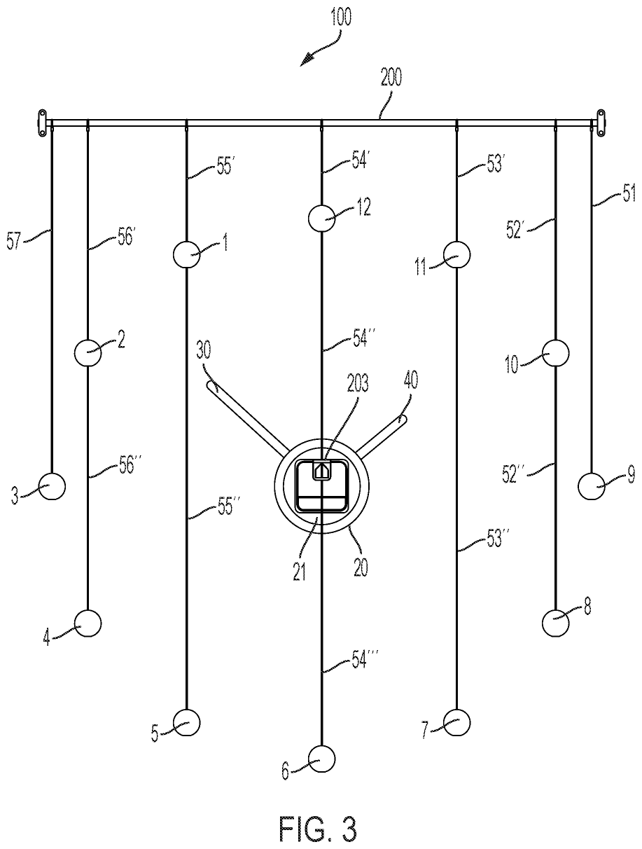

FIG. 3 is a rear elevational view of the suspended clock shown in FIG. 1 further illustrating the symmetrical nature of the invention and the size and location of the casing mounting bracket 203. Even in a rear view of suspended clock 100, suspension cables 51-57 and hour markers 1-12 are completely symmetric around casing 20 creating a perfect circle.

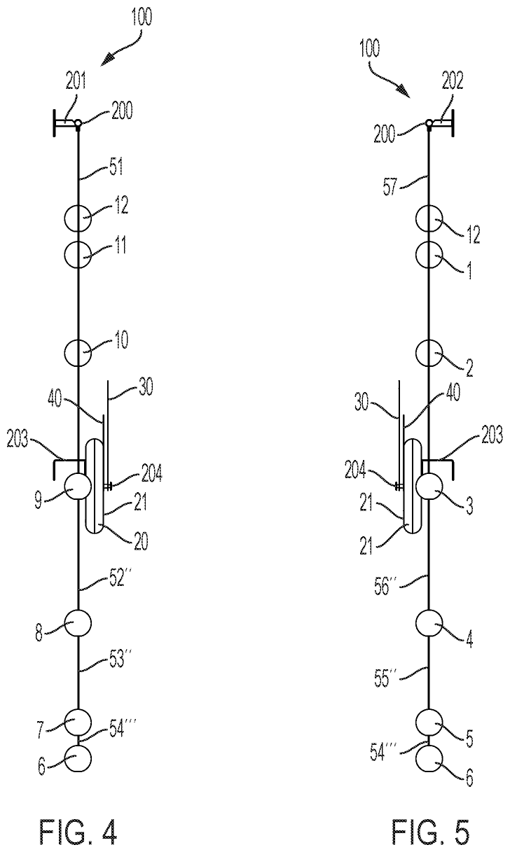

FIG. 4 is a left side elevational view of the suspended clock shown in FIG. 1 further illustrating the symmetric nature of suspended clock 100. It is shown that 12 o'clock hour marker 12 and 6 o'clock hour marker 6 are the highest and lowest hour markers, respectively. Additionally, from the left side and excluding hour markers 12 and 6, only the hour markers that are left of 12 o'clock hour marker 12 and 6 o'clock hour marker 6 are visible and the hour markers on the right side are not visible due to the precise uniformity between the left and right sides of the invention. 9 o'clock hour marker 9 and hand shaft 204 are equidistant from transverse support rod 200. Casing mounting bracket 203 is secured to casing 20 and is operatively arranged to secure to a wall surface some distance spaced apart from casing 20 for increased stability of casing 20. Likewise, transverse support rod mounting bracket 201 is secured to transverse support rod 200 and is operatively arranged to secure to a wall surface some distance spaced apart from transverse support rod. Meanwhile, transverse support rod bracket 201 and casing mounting bracket 20 secure to the same wall surface along substantially the same plane.

FIG. 5 is a right side elevational view of the suspended clock shown in FIG. 1 further illustrating the symmetric nature of suspended clock 100. It is shown that 12 o'clock hour marker 12 and 6 o'clock hour marker 6 are the highest and lowest hour markers, respectively. Additionally, from the right side and excluding hour markers 12 and 6, only the hour markers that are right of 12 o'clock hour marker 12 and 6 o'clock hour marker 6 are visible and the hour markers on the left side are not visible due to the precise uniformity between the right and left sides of the invention. 3 o'clock hour marker 3 and hand shaft 204 are equidistant from transverse support rod 200. Casing mounting bracket 203 is secured to casing 20 and is operatively arranged to secure to a wall surface some distance spaced apart from casing 20 for increased stability of casing 20. Likewise, transverse support rod mounting bracket 202 is secured to transverse support rod 200 and is operatively arranged to secure to a wall surface some distance spaced apart from transverse support rod. Meanwhile, transverse support rod bracket 202 and casing mounting bracket 20 secure to the same wall surface along substantially the same plane.

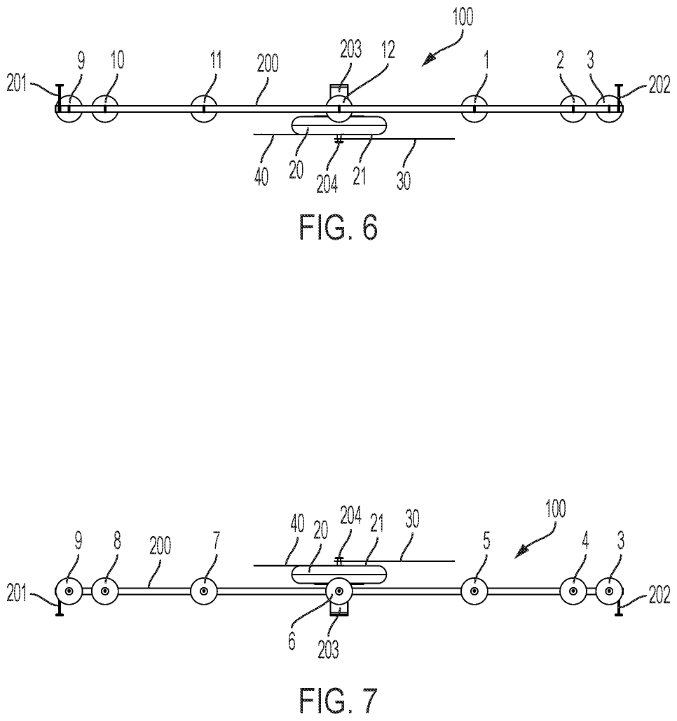

FIG. 6 is a top plan view of the suspended clock shown in FIG. 1 further illustrating the symmetric nature of suspended clock 100. It is shown that 9 o'clock hour marker 9 and 3 o'clock hour marker 3 are the widest hour markers. Additionally, from the top view, only the hour markers that are above 9 o'clock hour marker 9 and 3 o'clock hour marker 3 are visible along with 9 o'clock hour marker 9 and 3 o'clock hour marker 3, and the hour markers below 9 o'clock hour marker 9 and 3 o'clock hour marker 3 are not visible due to the precise uniformity between the hour markers 1-12 of the invention. 9 o'clock hour marker 9 and 3 o'clock hour marker 3 are equidistant from hand shaft 204.

FIG. 7 is a bottom plan view of the suspended clock shown in FIG. 1 further illustrating the symmetric nature of suspended clock 100. It is shown that 9 o'clock hour marker 9 and 3 o'clock hour marker 3 are the widest hour markers. Additionally, from the bottom view, only the hour markers that are below 9 o'clock hour marker 9 and 3 o'clock hour marker 3 are visible along with 9 o'clock hour marker 9 and 3 o'clock hour marker 3, and the hour markers above 9 o'clock hour marker 9 and 3 o'clock hour marker 3 are not visible due to the precise uniformity between the hour markers 1-12 of the invention.

It should be appreciated that the embodiment as shown is only one of a variety of possible embodiments of the claimed invention.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

1 1 o'clock hour marker
2 2 o'clock hour marker
3 3 o'clock hour marker
4 4 o'clock hour marker
5 5 o'clock hour marker
6 6 o'clock hour marker
7 7 o'clock hour marker
8 8 o'clock hour marker
9 9 o'clock hour marker
10 10 o'clock hour marker
11 11 o'clock hour marker
12 12 o'clock hour marker
20 casing
21 clock face
30 minute hand
40 hour hand
51 first suspension cable
52′ upper second suspension cable
52″ lower second suspension cable
53′ upper second suspension cable
53″ lower third suspension cable
54′ upper fourth suspension cable
54″ middle fourth suspension cable
54″ lower fourth suspension cable
55′ upper fifth suspension cable
55″ lower fifth suspension cable
56′ upper sixth suspension cable
56″ lower sixth suspension cable
57 seventh suspension cable
100 suspended clock
200 transverse support rod
201 first transverse support rod mounting bracket
202 second transverse support rod mounting bracket
203 casing mounting bracket
204 hand shaft

What is claimed is:

1. A suspended clock, comprising:
a transverse support rod;
a casing, said casing comprising a movement, a hand shaft engaging said movement and arranged for rotational timed movement, and at least two hands secured to said hand shaft and arranged for rotation about said hand shaft, said casing suspended from said transverse support rod; and,
a plurality of hour markers suspended from said transverse support rod, arranged in a circle, and spaced apart from said casing.

2. The suspended clock recited in claim 1 wherein each said hour marker is suspended by a suspension cable from said transverse support rod.

3. The suspended clock recited in claim 2 wherein each said hour marker is comprised of a sphere.

4. The suspended clock recited in claim 2 wherein each said hour marker is comprised of a cube.

5. The suspended clock recited in claim 2 wherein each said hour marker is comprised of a disk.

6. The suspended clock recited in claim 2 wherein each said hour marker is comprised of an octahedron.

7. The suspended clock recited in claim 2 wherein each said hour marker is obloid.

8. The suspended clock recited in claim 1 wherein said plurality of hour markers comprises a 1 o'clock hour marker, a 2 o'clock hour marker, a 3 o'clock hour marker, a 4 o'clock hour marker, a 5 o'clock hour marker, a 6 o'clock hour marker, a 7 o'clock hour marker, an 8 o'clock hour marker, a 9 o'clock hour marker, a 10 o'clock hour marker, an 11 o'clock hour marker and a 12 o'clock hour marker.

9. The suspended clock recited in claim 4 wherein the casing, the 1 o'clock hour marker and the 6 o'clock hour marker are all suspended from said transverse support rod by a fourth suspension cable, and said casing is suspended at a location between said 1 o'clock hour marker and said 6 o'clock hour marker.

10. The suspended clock recited in claim 4 wherein each of said 1 o'clock hour marker, 2 o'clock hour marker, 3 o'clock hour marker, 4 o'clock hour marker, 5 o'clock hour marker, 6 o'clock hour markers, 7 o'clock hour marker, 8 o'clock hour marker, 9 o'clock hour marker, 10 o'clock hour marker, 11 o'clock hour marker and 12 o'clock hour markers are positioned at identical radii from said hand shaft and arranged at an angle of thirty degrees relative to each adjacent hour marker.

11. The suspended clock recited in claim 1 wherein said at least two hands comprise a minute hand and an hour hand.

12. The suspended clock recited in claim 1 wherein said movement is a mechanical clock movement.

13. The suspended clock recited in claim 1 wherein said movement is an electric clock movement.

14. The suspended clock recited in claim 5 wherein each of said 1 o'clock hour marker, 2 o'clock hour marker, 3 o'clock hour marker, 4 o'clock hour marker, 5 o'clock hour marker, 7 o'clock hour marker, 8 o'clock hour marker, 9 o'clock hour marker, 10 o'clock hour marker and 11 o'clock hour markers are each suspended by suspension cables that are spaced apart and different than the fourth suspension cable that suspends the casing, the 6 o'clock hour marker and the 12 o'clock hour marker.

15. The suspended clock recited in claim 4 wherein the 2 o'clock hour marker and the 4 o'clock hour marker are both suspended from said transverse support rod by the sixth suspension cable.

16. The suspended clock recited in claim 4 wherein the 1 o'clock hour marker and the 5 o'clock hour marker are both suspended from said transverse support rod by the fifth suspension cable.

17. The suspended clock recited in claim 4 wherein the 7 o'clock hour marker and the 11 o'clock hour marker are both suspended from said transverse support rod by the third suspension cable.

18. The suspended clock recited in claim 4 wherein the 8 o'clock hour marker and the 10 o'clock hour marker are both suspended from said transverse support rod by the second suspension cable.

19. The suspended clock recited in claim 4 wherein the 3 o'clock hour marker is suspended from said transverse support rod by the seventh suspension cable.

20. The suspended clock recited in claim 4 wherein the 9 o'clock hour marker is suspended from said transverse support rod by the first suspension cable.
